(19) United States
(12) Patent Application Publication
(10) Pub. No.: US 2026/0145591 A1
(43) Pub. Date: May 28, 2026

(54) ACCELERATION REDUCTION DEVICE

(71) Applicant: AISIN CORPORATION, Kariya (JP)

(72) Inventors: Masashi NOBUTOKI, Kariya-shi (JP); Shintaro SUZUKI, Kariya-shi (JP)

(73) Assignee: AISIN CORPORATION, Kariya (JP)

(21) Appl. No.: 19/367,214

(22) Filed: Oct. 23, 2025

(30) Foreign Application Priority Data
Nov. 28, 2024 (JP) 2024-207443

(51) Int. Cl. B60N 2/10; B60N 2/02; F16H 19/04

(52) U.S. Cl. CPC B60N 2/10; B60N 2/02253; F16H 19/04

(57) ABSTRACT

An acceleration reduction device includes: first rack having plurality of first teeth arranged around virtual first central axis; first pinion meshing with first teeth; first drive device that rotates first pinion; second rack having plurality of second teeth that are arranged around virtual first central axis and have pitch circle diameter different from second teeth; second pinion meshing with second teeth; second drive device that rotates second pinion; and first driver that inputs common electric signal to first and second drive devices. First and second racks are apart from each other in direction along virtual first central axis, and first and second racks and first and second pinions are configured wherein first and second racks rotate synchronously about virtual first central axis when common electric signal is input to first and second drive devices.

### CROSS REFERENCE TO RELATED APPLICATIONS

This application is based on and claims priority under 35 U.S.C. § 119 to Japanese Patent Application No. 2024-207443, filed on Nov. 28, 2024, the entire content of which is incorporated herein by reference.

### TECHNICAL FIELD

The present disclosure relates to an acceleration reduction device.

### BACKGROUND DISCUSSION

When a vehicle or a conveyance robot travels, acceleration acts on a passenger on a seat surface of a seat of the vehicle or an object on a top surface of a table of the conveyance robot in a direction along these surfaces. Conventionally, there have been conducted research and development of an acceleration reduction device capable of reducing such acceleration (for example, JP 2023-104439 A).

For example, at the time of acceleration or deceleration or during traveling on an inclined surface, the acceleration reduction device causes a member such as a seat or a table having a surface on which a person or an object is placed to perform a pendulum motion. As a result, the acceleration reduction device can reduce the acceleration in a direction along the surface acting on the person or the object.

For example, a rack-and-pinion mechanism causes a member such as a seat or a table to perform a pendulum motion. That is, the rack-and-pinion mechanism includes: an arc-shaped rack connected to the member; and a pinion that rotates the rack. For example, a drive device including a motor and a reduction device rotates the pinion, so that the arc-shaped rack rotates.

It is also conceivable that a plurality of rack-and-pinion mechanisms are attached together to a member such as a seat or a table, and cause the member to perform a pendulum motion in cooperation. In this case, when the distances between a central axis of the pendulum motion and the plurality of racks are the same, a plurality of the drive devices driven by one driver can rotate the plurality of racks at substantially the same rotation speed.

However, it is not always possible to dispose the plurality of racks such that the distances between the plurality of racks and the central axis of the pendulum motion are substantially the same. When the distances between the central axis of the pendulum motion and the plurality of racks are different, pitch circle diameters of the plurality of racks are different from each other, and the reduction ratios of the plurality of rack-and-pinion mechanisms are accordingly different from each other. In this case, it is difficult for a single driver to rotate the plurality of racks at substantially the same rotation speed. That is, in the conventional configuration, the disposition of the racks is limited.

A need thus exists for an acceleration reduction device which is not susceptible to the drawback mentioned above.

### SUMMARY

An acceleration reduction device includes: a first rack having a plurality of first teeth arranged around a virtual first central axis; a first pinion that meshes with the plurality of first teeth; a first drive device configured to rotate the first pinion; a second rack having a plurality of second teeth arranged around the virtual first central axis; a second pinion that meshes with the plurality of second teeth; a second drive device configured to rotate the second pinion; and a first driver that inputs a common electric signal to the first drive device and the second drive device. The first rack and the second rack are apart from each other in a first axial direction along the virtual first central axis, a diameter of a pitch circle of the plurality of first teeth is different from a diameter of a pitch circle of the plurality of second teeth, and a reduction ratio of the first rack and the first pinion and a reduction ratio of the second rack and the second pinion are set such that the first rack and the second rack rotate synchronously about the virtual first central axis with respect to the first pinion and the second pinion when the first driver inputs the common electric signal to the first drive device and the second drive device.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view schematically illustrating a part of a vehicle according to one embodiment;

FIG. 2 is a perspective view illustrating the acceleration reduction device according to the embodiment;

FIG. 3 is a side view illustrating the acceleration reduction device according to the embodiment;

FIG. 4 is a perspective view illustrating an acceleration reduction device in which a second rotation mechanism of the embodiment is rotated; and

FIG. 5 is a front view schematically illustrating a first rotation mechanism of the embodiment.

### DETAILED DESCRIPTION

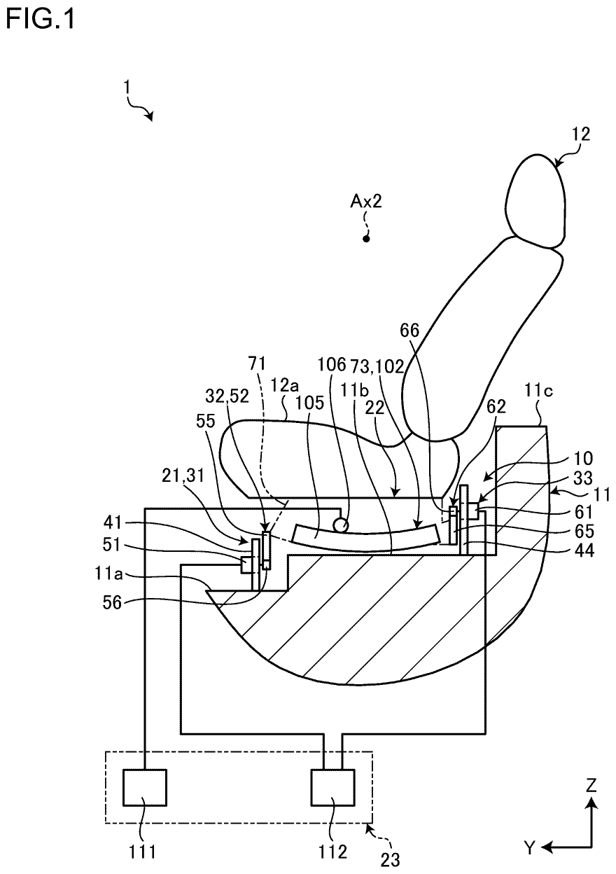

Hereinafter, an acceleration reduction device 10 of one embodiment will be described with reference to FIGS. 1 to 5. In the present specification, a component according to an embodiment and a description of the component are sometimes described in plural form. The component and the description thereof are just examples, and are not limited by the expression of the present specification. Components can be specified also with names different from those in the present specification. In addition, components can be described by expressions different from those in the present specification.

FIG. 1 is a side view schematically illustrating a part of a vehicle 1 according to the present embodiment. As illustrated in FIG. 1, the acceleration reduction device 10 of the present embodiment is mounted on the vehicle 1 such as an automobile. The acceleration reduction device 10 can reduce acceleration acting on a passenger of the vehicle 1 in a front-rear direction and a right-left direction of the vehicle 1, for example. Note that the acceleration reduction device 10 is not limited to this example.

As illustrated in the drawings, in the present specification, an X-axis, a Y-axis, and a Z-axis are defined for convenience. The X-axis, the Y-axis, and the Z-axis are orthogonal to each other. The X-axis extends in the right-left direction of the vehicle 1. The Y-axis extends in the front-rear direction of the vehicle 1. The Z-axis extends in the vertical direction of the vehicle 1.

Furthermore, in the present specification, an X direction, a Y direction, and a Z direction are defined. The X direction is the direction along the X-axis and includes a +X direction (right direction) indicated by an arrow of the X-axis and a-X direction (left direction) that is an opposite direction of the arrow of the X-axis. The Y direction is the direction along the Y-axis and includes a +Y direction (forward direction) indicated by an arrow of the Y-axis and a-Y direction (backward direction) that is an opposite direction of the arrow of the Y-axis. The Z direction is the direction along the Z-axis and includes a +Z direction (upward direction) indicated by an arrow of the Z-axis and a-Z direction (downward direction) opposite to the arrow of the Z-axis.

The acceleration reduction device 10 may be mounted not only on the vehicle 1 but also on another device such as an autonomous traveling robot (autonomous mobile body). In this case, the acceleration reduction device 10 reduces the acceleration in the front-rear direction and the right-left direction acting on an object conveyed by the autonomous traveling robot.

As illustrated in FIG. 1, the vehicle 1 of the present embodiment includes the acceleration reduction device 10, a floor 11, and a seat 12. The acceleration reduction device 10 is provided between the floor 11 and the seat 12. Note that the acceleration reduction device 10 may be provided at another position.

The floor 11 has a plurality of floor surfaces 11a, 11b, and 11c. The floor surface 11a is located below the floor surfaces 11b and 11c. For example, the passenger of the vehicle 1 places his or her feet on the floor surface 11a.

The floor surface 11b is located between the floor surface 11a and the floor surface 11c in the Y direction. The floor surface 11c is apart from the floor surface 11a in the −Y direction and is located above the floor surfaces 11a and 11b. For example, a load is placed on the floor surface 11c.

The vehicle 1 includes a battery under the floor surface 11b, for example. The floor 11 is formed such that the floor surface 11b is higher than the floor surface 11a, in order to form a space in which the battery is disposed.

Under the floor surface 11b, there may be disposed another part such as a propeller shaft or a drive shaft.

The seat 12 in the example of FIG. 1 is, for example, a rear seat. Note that the seat 12 is not limited to this example. The seat 12 has a seat surface 12a. For example, the passenger of the vehicle 1 sits on the seat surface 12a. The seat surface 12a faces substantially the +Z direction as a whole.

The acceleration reduction device 10 includes a first rotation mechanism 21, a second rotation mechanism 22, and an electronic control unit (ECU) 23. However, in the acceleration reduction device 10, the second rotation mechanism 22 may be omitted.

The first rotation mechanism 21 is attached to the floor 11 and is interposed between the floor 11 and the second rotation mechanism 22. The second rotation mechanism 22 is attached to the seat 12 and is interposed between the seat 12 and the first rotation mechanism 21. Note that positions of the first rotation mechanism 21 and the second rotation mechanism 22 are not limited to this example. For example, the second rotation mechanism 22 may be interposed between the floor 11 and the first rotation mechanism 21, and the first rotation mechanism 21 may be interposed between the seat 12 and the second rotation mechanism 22.

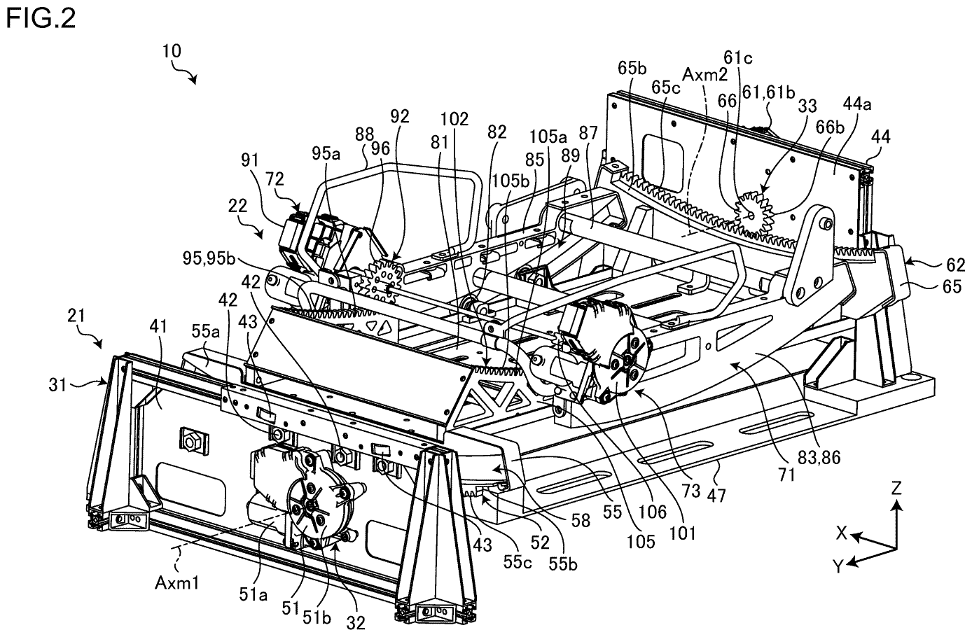

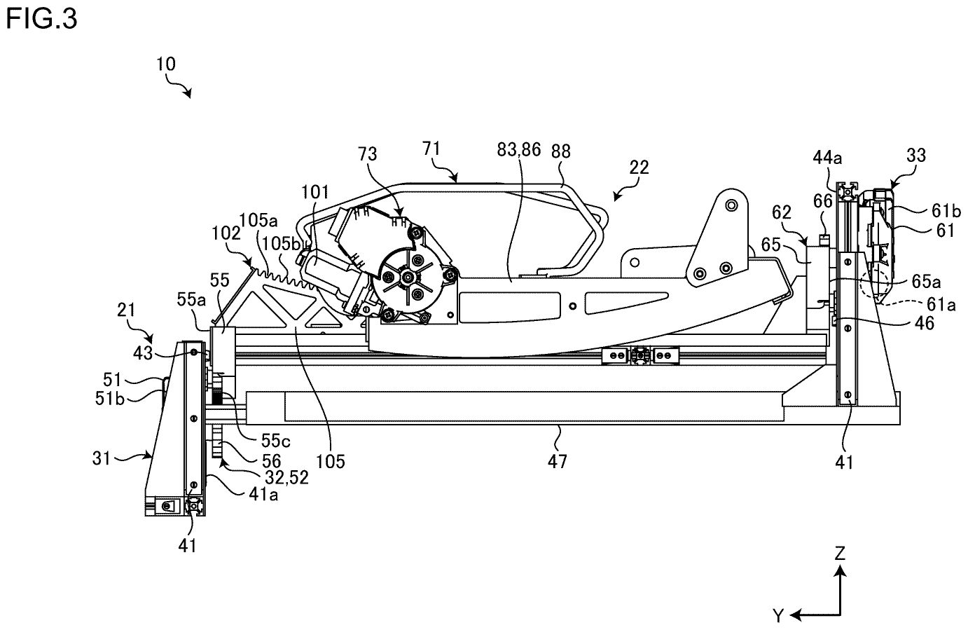

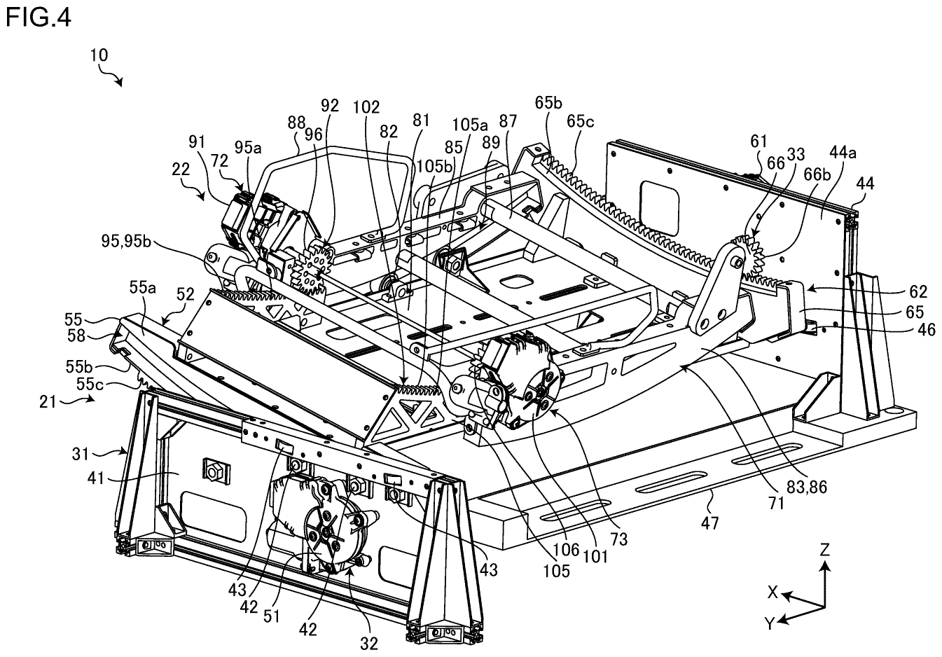

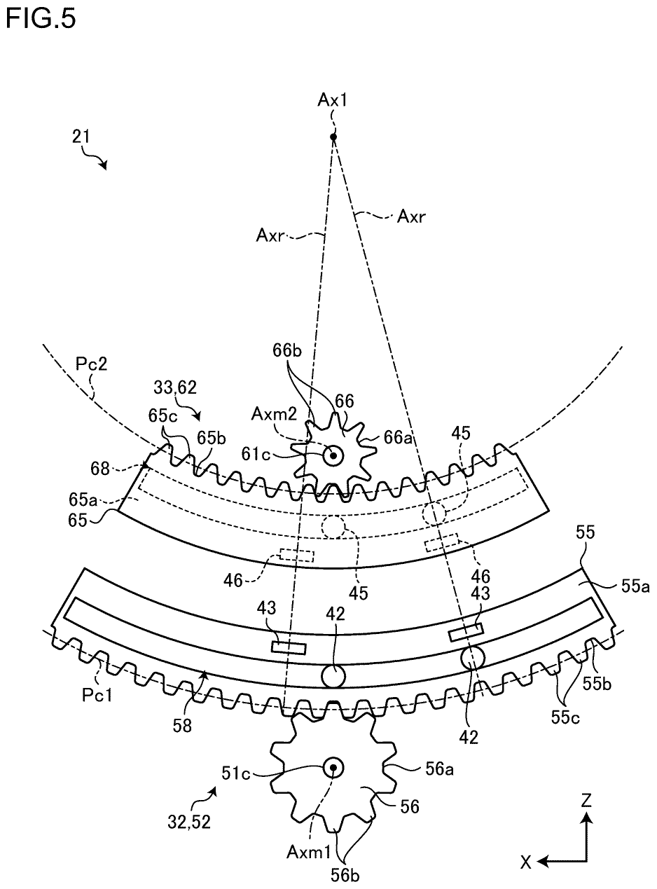

FIG. 2 is a perspective view illustrating the acceleration reduction device 10 of the present embodiment. FIG. 3 is a side view illustrating the acceleration reduction device 10 of the present embodiment. FIG. 4 is a perspective view illustrating the acceleration reduction device 10 in which the second rotation mechanism 22 of the present embodiment is rotated. FIG. 5 is a front view schematically illustrating the first rotation mechanism 21 of the present embodiment.

In the present embodiment, the first rotation mechanism 21 can cause the seat 12 to perform a pendulum motion in approximately the X direction (right-left direction). Specifically, the first rotation mechanism 21 can rotate the second rotation mechanism 22 and the seat 12 about a first central axis Ax1 illustrated in FIG. 5 with respect to the floor 11. The first central axis Ax1 is a virtual central axis of the rotation of the seat 12.

In the present embodiment, the first central axis Ax1 is located above the first rotation mechanism 21 and the second rotation mechanism 22 and extends in substantially the Y direction (the front-rear direction of the vehicle 1). Note that the first central axis Ax1 may be located below the first rotation mechanism 21 and the second rotation mechanism 22 and may extend in another direction. For example, the first central axis Ax1 may extend in substantially the X direction (the right-left direction of the vehicle 1). In this case, the first rotation mechanism 21 can cause the seat 12 to perform a pendulum motion in approximately the Y direction (front-rear direction).

On the other hand, the second rotation mechanism 22 can cause the seat 12 to perform a pendulum motion in approximately the Y direction (front-rear direction). Specifically, the second rotation mechanism 22 can rotate the seat 12 about a second central axis Ax2 illustrated in FIG. 1 with respect to the first rotation mechanism 21. The second central axis Ax2 is a virtual central axis of the rotation of the seat 12.

In the present embodiment, the second central axis Ax2 is located above the second rotation mechanism 22 and extends in substantially the X direction. That is, a direction (second axial direction) in which the second central axis Ax2 extends intersects (orthogonally, in the present embodiment) a direction along the first central axis Ax1 (first axial direction).

The second central axis Ax2 may be located below the second rotation mechanism 22 and may extend in another direction. For example, when the direction in which the second central axis Ax2 extends and the direction along the first central axis Ax1 intersect, the second central axis Ax2 may extend in substantially the Y direction (the front-rear direction of the vehicle 1). In this case, the second rotation mechanism 22 can cause the seat 12 to perform a pendulum motion in approximately the X direction (right-left direction). When the first rotation mechanism 21 rotates the second rotation mechanism 22, the second central axis Ax2 also rotates about the first central axis Ax1.

As illustrated in FIG. 2, the first rotation mechanism 21 includes a base 31, a front actuator 32, and a rear actuator 33. Note that the first rotation mechanism 21 may not include just two actuators (the front actuator 32 and the rear actuator 33), but may include three or more actuators.

The base 31 includes: a front support plate (first support portion) 41, a plurality of front support rollers 42, a plurality of front guide rollers (first rollers) 43, a rear support plate (second support portion) 44, which are illustrated in FIG. 4; a plurality of rear support rollers 45 and a plurality of rear guide rollers (second rollers) 46, which are illustrated in FIG. 5; and a connection member 47 illustrated in FIG. 4.

As illustrated in FIG. 1, the front support plate 41 is attached to the floor surface 11a to extend in substantially the +Z direction from the floor surface 11a of the floor 11. The front support plate 41 is formed in a plate shape disposed along an X-Z plane, for example. As illustrated in FIG. 3, the front support plate 41 has a rear surface 41a. The rear surface 41a is formed to be substantially flat and faces substantially the-Y direction.

As illustrated in FIG. 2, the plurality of front support rollers 42 are attached to the front support plate 41. Each of the plurality of front support rollers 42 is attached to a shaft protruding in substantially the-Y direction from the rear surface 41a of the front support plate 41.

Each front support roller 42 is rotatable about a central axis of the front support roller 42 with respect to the front support plate 41. The central axes of the front support rollers 42 extend in substantially the Y direction. Each of the plurality of front support rollers 42 has a bearing and can rotate smoothly. As illustrated in FIG. 5, the plurality of front support rollers 42 are arranged at intervals around the first central axis Ax1.

As illustrated in FIG. 2, the plurality of front guide rollers 43 are attached to the front support plate 41. Each of the plurality of front guide rollers 43 is fitted in, for example, a groove penetrating through the front support plate 41 in substantially the Y direction. As illustrated in FIG. 3, part of each front guide roller 43 protrudes in substantially the −Y direction from the rear surface 41a of the front support plate 41.

Each front guide roller 43 is rotatable about a central axis (third central axis) Axr of the front guide roller 43 illustrated in FIG. 5 with respect to the front support plate 41. The central axes Axr extend in radial directions orthogonal to the first central axis Ax1. The plurality of front guide rollers 43 are arranged at intervals around the first central axis Ax1.

As illustrated in FIG. 1, the rear support plate 44 is attached to the floor surface 11b to extend in substantially the +Z direction from the floor surface 11b of the floor 11. That is, the rear support plate 44 is apart from the front support plate 41 in substantially the −Y direction. In other words, the front support plate 41 and the rear support plate 44 are apart from each other in the direction along the first central axis Ax1 (first axial direction).

The rear support plate 44 is formed in a plate shape arranged along the X-Z plane, for example. As illustrated in FIG. 2, the rear support plate 44 has a front surface 44a. The front surface 44a is formed to be substantially flat and faces substantially the +Y direction.

The plurality of rear support rollers 45 are attached to the rear support plate 44. Each of the plurality of rear support rollers 45 is attached to a shaft protruding in substantially the +Y direction from the front surface 44a of the rear support plate 44.

Each rear support roller 45 is rotatable about a central axis of the rear support roller 45 with respect to the rear support plate 44. The central axes of the rear support rollers 45 extend in substantially the Y direction. Each of the plurality of rear support rollers 45 has a bearing and can rotate smoothly. As illustrated in FIG. 5, the plurality of rear support rollers 45 are arranged at intervals around the first central axis Ax1.

As illustrated in FIG. 4, the plurality of rear guide rollers 46 are attached to the rear support plate 44. Each of the plurality of rear guide rollers 46 is fitted in a groove penetrating through the rear support plate 44 in substantially the Y direction, for example. Part of each rear guide roller 46 protrudes in substantially the +Y direction from the front surface 44a of the rear support plate 44.

Each rear guide roller 46 is rotatable about a central axis (fourth central axis) Axr of the rear guide roller 46 with respect to the rear support plate 44. As illustrated in FIG. 5, the plurality of rear guide rollers 46 are arranged around the first central axis Ax1.

As illustrated in FIG. 2, the connection member 47 extends in substantially the Y direction along the floor surface 11b of the floor 11. The connection member 47 is attached to the front support plate 41 and the rear support plate 44. The connection member 47 may be attached to the floor surface 11b.

The front actuator 32 includes a first drive device 51 and a first rack-and-pinion mechanism 52. The first drive device 51 may also be referred to as a motor gear box, for example.

The first drive device 51 is attached to the front support plate 41. That is, the front support plate 41 supports the first drive device 51. The first drive device 51 includes, for example: a motor 51a and a reduction device 51b, which are illustrated in FIG. 2; and an output shaft 51c illustrated in FIG. 5.

The motor 51a is, for example, a DC motor. Note that the motor 51a may be another type of motor. The reduction device 51b reduces a rotation of a shaft of the motor 51a and transmits the reduced rotation to the output shaft 51c. The output shaft 51c protrudes in substantially the-Y direction from the reduction device 51b. The output shaft 51c passes through a hole provided in the front support plate 41 and protrudes beyond the rear surface 41a of the front support plate 41, for example.

The first drive device 51 rotates the output shaft 51c about a central axis Axm1 of the output shaft 51c with respect to the front support plate 41. The central axis Axm1 extends in the Y direction. That is, the central axis Axm1 extends in the direction (first axial direction) in which the first central axis Ax1 extends.

The first drive device 51 drives the first rack-and-pinion mechanism 52 by rotating the output shaft 51c. The first rack-and-pinion mechanism 52 includes a first rack 55 and a first pinion 56.

As illustrated in FIG. 2, the first rack 55 is located between the front support plate 41 and the rear support plate 44. Note that the first rack 55 may be provided at another position. For example, the first rack 55 is formed in a plate shape disposed along the X-Z plane. The first rack 55 has a front surface (surface) 55a, a lower edge 55b, and a plurality of first teeth 55c.

The front surface 55a is formed to be substantially flat and faces substantially the +Y direction. As illustrated in FIG. 3, the front surface 55a of the first rack 55 and the rear surface 41a of the front support plate 41 face each other with a gap. In the present embodiment, the front surface 55a is apart from the front guide rollers 43. Note that the plurality of front guide rollers 43 may be constantly in contact with the front surface 55a.

As illustrated in FIG. 5, the lower edge 55b is provided at an end of the first rack 55 on a radially outer side. The lower edge 55b extends in an arc shape around the first central axis Ax1. In the present embodiment, the lower edge 55b faces substantially the-Z direction as a whole.

Each of the plurality of first teeth 55c protrudes radially outward from the lower edge 55b. That is, the plurality of first teeth 55c protrude in substantially the-Z direction (downward direction) from the lower edge 55b. The plurality of first teeth 55c are arranged around the first central axis Ax1. The lower edge 55b forms tooth bottoms of the plurality of first teeth 55c.

A groove 58 is provided in the first rack 55. The groove 58 is recessed in substantially the-Y direction from the front surface 55a of the first rack 55 and extends in an arc shape around the first central axis Ax1. The groove 58 may penetrate through the first rack 55 in substantially the Y direction.

The plurality of front support rollers 42 are accommodated in the groove 58. The front support rollers 42 can support the first rack 55 by being in contact with an inner surface defining the groove 58 of the first rack 55. The plurality of front support rollers 42 are arranged around the first central axis Ax1, and the groove 58 extends around the first central axis Ax1; therefore, the first rack 55 can rotate about the first central axis Ax1 with respect to the base 31.

The first pinion 56 is attached to the output shaft 51c of the first drive device 51. Therefore, the central axis Axm1 of the output shaft 51c is also a central axis of the first pinion 56. By rotating the output shaft 51c, the first drive device 51 rotates the first pinion 56 about the central axis Axm1 of the output shaft 51c.

The first pinion 56 has an outer peripheral surface 56a and a plurality of pinion teeth 56b. The outer peripheral surface 56a is a curved surface in a substantially cylindrical shape extending along the central axis Axm1 of the output shaft 51c. The plurality of pinion teeth 56b protrude from the outer peripheral surface 56a to be arranged around the central axis Axm1. The outer peripheral surface 56a forms tooth bottoms of the plurality of pinion teeth 56b.

In the present embodiment, the first pinion 56 is located below the first rack 55. The plurality of pinion teeth 56b of the first pinion 56 mesh with the plurality of first teeth 55c of the first rack 55. Therefore, when the first drive device 51 rotates the output shaft 51c, the first pinion 56 rotates, so that the first rack 55 rotates (swings) about the first central axis Ax1 with respect to the first pinion 56. The first pinion 56 may be disposed above the first rack 55 or at another position according to the direction in which the first teeth 55c are directed.

As illustrated in FIG. 3, the rear actuator 33 includes a second drive device 61 and a second rack-and-pinion mechanism 62. The second drive device 61 may also be referred to as a motor gear box, for example.

The second drive device 61 is attached to the rear support plate 44. That is, the rear support plate 44 supports the second drive device 61. The second drive device 61 includes, for example: a motor 61a and a reduction device 61b, which are illustrated in FIG. 3; and an output shaft 61c illustrated in FIG. 5.

The motor 61a is the same DC motor as the motor 51a of the first drive device 51, for example. The reduction device 61b is the same reduction device as the reduction device 51b of the first drive device 51, for example. The motor 61a and the reduction device 61b are not limited to this example.

The reduction device 61b reduces a rotation of a shaft of the motor 61a and transmits the reduced rotation to the output shaft 61c. The output shaft 61c protrudes in substantially the +Y direction from the reduction device 61b. The output shaft 61c passes through a hole provided in the rear support plate 44 and protrudes beyond the front surface 44a of the rear support plate 44, for example.

The second drive device 61 rotates the output shaft 61c about a central axis Axm2 of the output shaft 61c with respect to the rear support plate 44. As illustrated in FIG. 5, the central axis Axm2 extends in the Y direction. That is, the central axis Axm2 extends in the direction (first axial direction) in which the first central axis Ax1 extends.

The second drive device 61 drives the second rack-and-pinion mechanism 62 by rotating the output shaft 61c. The second rack-and-pinion mechanism 62 includes a second rack 65 and a second pinion 66.

As illustrated in FIG. 2, the second rack 65 is located between the front support plate 41 and the rear support plate 44. Note that the second rack 65 may be provided at another position. The second rack 65 is apart from the first rack 55 in the-Y direction. That is, the first rack 55 and the second rack 65 are apart from each other in the direction along the first central axis Ax1 (first axial direction). Since the first central axis Ax1 extends in the Y direction (front-rear direction), the first rack 55 and the second rack 65 are apart from each other in the horizontal direction.

For example, the second rack 65 is formed in a plate shape disposed along the X-Z plane. The second rack 65 has a rear surface 65a illustrated in FIG. 3, an upper edge 65b illustrated in FIG. 5, and a plurality of second teeth 65c.

As illustrated in FIG. 3, the rear surface 65a is formed to be substantially flat and faces substantially the-Y direction. The rear surface 65a of the second rack 65 and the front surface 44a of the rear support plate 44 face each other with a gap. In the present embodiment, the rear surface 65a is apart from the rear guide rollers 46. Note that the plurality of rear guide rollers 46 may be constantly in contact with the rear surface 65a.

As illustrated in FIG. 5, the upper edge 65b is provided at an end of the second rack 65 on a radially inward side. The upper edge 65b extends in an arc shape around the first central axis Ax1. In the present embodiment, the upper edge 65b faces substantially the +Z direction as a whole.

Each of the plurality of second teeth 65c protrudes radially inward from the upper edge 65b. That is, the plurality of second teeth 65c protrude from the upper edge 65b in substantially the +Z direction (upward direction). The plurality of second teeth 65c are arranged around the first central axis Ax1. The upper edge 65b forms tooth bottoms of the plurality of second teeth 65c.

A groove 68 is provided in the second rack 65. The groove 68 is recessed in substantially the +Y direction from the rear surface 65a of the second rack 65 and extends in an arc shape around the first central axis Ax1. The groove 68 may penetrate through the second rack 65 in substantially the Y direction.

A plurality of rear support rollers 45 are accommodated in the groove 68. The rear support rollers 45 can support the second rack 65 by being in contact with an inner surface defining the groove 68 of the second rack 65. The plurality of rear support rollers 45 are arranged around the first central axis Ax1, and the groove 68 extends around the first central axis Ax1; therefore, the second rack 65 can rotate about the first central axis Ax1 with respect to the base 31.

The second pinion 66 is attached to the output shaft 61c of the second drive device 61. Therefore, the central axis Axm2 of the output shaft 61c is also a central axis of the second pinion 66. By rotating the output shaft 61c, the second drive device 61 rotates the second pinion 66 about the central axis Axm2 of the output shaft 61c.

The second pinion 66 has an outer peripheral surface 66a and a plurality of pinion teeth 66b. The outer peripheral surface 66a is a curved surface in a substantially cylindrical shape extending along the central axis Axm2 of the output shaft 61c. The plurality of pinion teeth 66b protrude from the outer peripheral surface 66a to be arranged around the central axis Axm2. The outer peripheral surface 66a forms tooth bottoms of the plurality of pinion teeth 66b.

In the present embodiment, the second pinion 66 is located above the second rack 65. The plurality of pinion teeth 66b of the second pinion 66 mesh with the plurality of second teeth 65c of the second rack 65. Therefore, when the second drive device 61 rotates the output shaft 61c, the second pinion 66 rotates, so that the second rack 65 rotates (swings) about the first central axis Ax1 with respect to the second pinion 66. The second pinion 66 may be disposed below the second rack 65 or at another position according to the direction in which the second teeth 65c are directed.

In the present embodiment, the central axis Axm1 of the output shaft 51c of the first drive device 51 and the central axis Axm2 of the output shaft 61c of the second drive device 61 are located below the first central axis Ax1. The central axis Axm2 is located on a straight line connecting the first central axis Ax1 and the central axis Axm1. That is, the first central axis Ax1, the central axis Axm1, and the central axis Axm2 are linearly arranged in the radial direction. Note that the central axis Axm1 and the central axis Axm2 may be disposed at other positions.

The plurality of first teeth 55c of the first rack 55 and the plurality of second teeth 65c of the second rack 65 are both arranged around the first central axis Ax1. However, a diameter of a pitch circle Pc1 of the plurality of first teeth 55c is different from a diameter of a pitch circle Pc2 of the plurality of second teeth 65c.

In the present embodiment, the first rack 55 is located below the second rack 65. Therefore, the plurality of first teeth 55c of the first rack 55 are more apart from the first central axis Ax1 than the plurality of second teeth 65c of the second rack 65. That is, the diameter of the pitch circle Pc1 is larger than the diameter of the pitch circle Pc2.

A reduction ratio i₁ of the first rack-and-pinion mechanism 52 and a reduction ratio i₂ of the second rack-and-pinion mechanism 62 are set to be substantially equal. Specifically, a difference between the reduction ratio i₁ of the first rack 55 and the first pinion 56 and the reduction ratio i₂ of the second rack 65 and the second pinion 66 may be set to 1% or less of the reduction ratio i₁. Note that the difference between the reduction ratio i₁ and the reduction ratio i₂ may be 1% or more.

For example, in the calculation of the reduction ratio i₁, the number of teeth of the plurality of first teeth 55c of the first rack 55 is 689. The number of teeth of the plurality of first teeth 55c in the calculation of the reduction ratio i₁ is not the actual number of teeth of the first teeth 55c, but the number of teeth of the first teeth 55c in a case where a plurality of first teeth 55c are arranged in 360° around the first central axis Ax1. The number of teeth of the first teeth 55c can be calculated based on, for example, the diameter of the pitch circle Pc1 and a pitch of the plurality of first teeth 55c.

The number of teeth of the plurality of pinion teeth 56b of the first pinion 56 is 20. Therefore, the reduction ratio i₁ of the first rack 55 and the first pinion 56 is 34.45(34.45:1).

In the calculation of reduction ratio i₂, the number of teeth of the plurality of second teeth 65c of the second rack 65 is 585. The number of teeth of the plurality of second teeth 65c in the calculation of the reduction ratio i₂ is not the actual number of teeth of the second teeth 65c, but the number of teeth of the second teeth 65c in a case where a plurality of second teeth 65c are arranged in 360° around the first central axis Ax1. The number of teeth of the second teeth 65c can be calculated based on, for example, the diameter of the pitch circle Pc2 and a pitch of the plurality of second teeth 65c.

The number of teeth of the plurality of pinion teeth 66b of the second pinion 66 is 17. Therefore, the reduction ratio i₂ of the second rack 65 and the second pinion 66 is about 34.41 (34.41:1).

The difference between the reduction ratio i₁ and the reduction ratio i₂ is about 0.04. In comparison, 1% of the reduction ratio i₁ is about 0.34. As described above, the difference between the reduction ratio i₁ and the reduction ratio i₂ is 1% or less of the reduction ratio i₁. Note that the number of teeth of the plurality of first teeth 55c, the number of teeth of the plurality of pinion teeth 56b, the number of teeth of the plurality of second teeth 65c, the number of teeth of the plurality of pinion teeth 66b, the reduction ratio i₁, and the reduction ratio i₂ are merely examples, and do not limit the numbers and the reduction ratios.

As illustrated in FIG. 4, the second rotation mechanism 22 includes a seat base 71, a right actuator 72, and a left actuator 73. Note that the second rotation mechanism 22 may not include just two actuators (the right actuator 72 and the left actuator 73), but may include three or more actuators.

The seat base 71 includes a base frame 81, a plurality of support rollers 82, and a seat frame 83.

The base frame 81 is provided between the first rack 55 and the second rack 65, and is connected to the first rack 55 and the second rack 65. That is, the base frame 81 is attached to the first rotation mechanism 21.

Each support roller 82 is attached to the base frame 81 to be rotatable about a central axis of the support roller 82. The central axes of the support rollers 82 extend in a direction along the second central axis Ax2 (second axial direction). The plurality of support rollers 82 have bearings and can rotate smoothly. The plurality of support rollers 82 are arranged around the second central axis Ax2.

The seat frame 83 includes a right rail 85, a left rail 86, a plurality of beams 87, and a wire frame 88. The right rail 85 and the left rail 86 are each formed in a plate shape arranged to be substantially orthogonal to the direction along the second central axis Ax2 (second axial direction). The right rail 85 is apart from the left rail 86 in substantially the +X direction. That is, the right rail 85 and the left rail 86 are apart from each other in the direction along the second central axis Ax2 (second axial direction).

Each of the plurality of beams 87 connects the right rail 85 and the left rail 86 to each other. The wire frame 88 is attached to the right rail 85 and the left rail 86 and is connected to the seat 12. The wire frame 88 holds, for example, a cushion of the seat 12.

A groove 89 is provided in each of the right rail 85 and the left rail 86. The grooves 89 extend around the second central axis Ax2. A plurality of the support rollers 82 are accommodated in each of the two grooves 89.

The plurality of support rollers 82 can support the right rail 85 and the left rail 86 by being in contact with inner surfaces defining the grooves 89. The plurality of support rollers 82 are arranged around the second central axis Ax2, and the grooves 89 extend around the second central axis Ax2; therefore, the right rail 85 and the left rail 86 can rotate about the second central axis Ax2 with respect to the base frame 81.

The right actuator 72 includes a third drive device 91 and a third rack-and-pinion mechanism 92. The third drive device 91 may also be referred to as a motor gear box, for example.

The third drive device 91 is attached to the right rail 85. The third drive device 91 includes, for example, a motor, a reduction device, and an output shaft. The reduction device transmits rotation of a shaft of the motor to the output shaft.

The third drive device 91 drives the third rack-and-pinion mechanism 92 by rotating the output shaft of the third drive device 91. The third rack-and-pinion mechanism 92 includes a third rack 95 and a third pinion 96.

The third rack 95 is attached to the base frame 81. The third rack 95 is located between the right rail 85 and the left rail 86. Note that the third rack 95 may be provided at another position. The third rack 95 is formed in a plate shape disposed to be orthogonal to the direction along the second central axis Ax2 (second axial direction), for example. The third rack 95 includes an upper edge 95a and a plurality of third teeth 95b.

The upper edge 95a extends in an arc shape around the second central axis Ax2 and faces the second central axis Ax2. In the present embodiment, the upper edge 95a faces substantially the +Z direction as a whole. Each of the plurality of third teeth 95b protrudes from the upper edge 95a toward the second central axis Ax2. That is, the plurality of third teeth 95b protrude in substantially the +Z direction (upward direction) from the upper edge 95a. The plurality of third teeth 95b are arranged around the second central axis Ax2. The upper edge 95a forms tooth bottoms of the plurality of third teeth 95b.

The third pinion 96 is attached to the output shaft of the third drive device 91. The third drive device 91 rotates the third pinion 96 about a central axis of the third pinion 96. The central axis of the third pinion 96 extends in the direction along the second central axis Ax2 (second axial direction).

In the present embodiment, the third pinion 96 is located above the third rack 95. A plurality of teeth of the third pinion 96 mesh with the plurality of third teeth 95b of the third rack 95. Therefore, when the third drive device 91 rotates the third pinion 96, the third rack 95 rotates (swings) about the second central axis Ax2 with respect to the third pinion 96. The third pinion 96 may be disposed below the third rack 95 or at another position according to the direction in which the third teeth 95b are directed.

The left actuator 73 has a fourth drive device 101 and a fourth rack-and-pinion mechanism 102. The fourth drive device 101 may also be referred to as a motor gear box, for example.

The fourth drive device 101 is attached to the left rail 86. The fourth drive device 101 includes, for example, a motor, a reduction device, and an output shaft. The motor and the reduction device of the fourth drive device 101 are the same as the motor and the reduction device of the third drive device 91. Note that the fourth drive device 101 is not limited to this example.

The fourth drive device 101 drives the fourth rack-and-pinion mechanism 102 by rotating the output shaft of the fourth drive device 101. The fourth rack-and-pinion mechanism 102 includes a fourth rack 105 and a fourth pinion 106.

The fourth rack 105 is attached to the base frame 81. As described above, the third rack 95 is also attached to the base frame 81. That is, the first rotation mechanism 21 is attached to the second rotation mechanism 22. When the first rack 55 and the second rack 65 rotate about the first central axis Ax1 with respect to the base 31, the second rotation mechanism 22 also rotates about the first central axis Ax1 with respect to the base 31.

The fourth rack 105 is located between the right rail 85 and the left rail 86. Note that the fourth rack 105 may be provided at another position. The fourth rack 105 is apart from the third rack 95 in the −X direction. That is, the third rack 95 and the fourth rack 105 are apart from each other in the direction along the second central axis Ax2 (second axial direction). Since the second central axis Ax2 extends in substantially the X direction (right-left direction), the third rack 95 and the fourth rack 105 are apart from each other in the horizontal direction.

The fourth rack 105 is formed in a plate shape disposed to be orthogonal to the direction along the second central axis Ax2 (second axial direction), for example. The fourth rack 105 includes an upper edge 105a and a plurality of fourth teeth 105b.

The upper edge 105a extends in an arc shape around the second central axis Ax2 and faces the second central axis Ax2. In the present embodiment, the upper edge 105a faces substantially the +Z direction as a whole. Each of the plurality of fourth teeth 105b protrudes from the upper edge 105a toward the second central axis Ax2. That is, the plurality of fourth teeth 105b protrude from the upper edge 105a in substantially the +Z direction (upward direction). The plurality of fourth teeth 105b are arranged around the second central axis Ax2. The upper edge 105a forms tooth bottoms of the plurality of fourth teeth 105b.

The fourth pinion 106 is attached to the output shaft of the fourth drive device 101. The fourth drive device 101 rotates the fourth pinion 106 about a central axis of the fourth pinion 106. The central axis of the fourth pinion 106 extends in the direction along the second central axis Ax2 (second axial direction).

In the present embodiment, the fourth pinion 106 is located above the fourth rack 105. A plurality of teeth of the fourth pinion 106 mesh with the plurality of fourth teeth 105b of the fourth rack 105. Therefore, when the fourth drive device 101 rotates the fourth pinion 106, the fourth rack 105 rotates (swings) about the second central axis Ax2 with respect to the fourth pinion 106. The fourth pinion 106 may be disposed below the fourth rack 105 or at another position according to the direction in which the fourth teeth 105b are directed.

In the present embodiment, a diameter of the pitch circle of the plurality of third teeth 95b is equal to a diameter of the pitch circle of the plurality of fourth teeth 105b. Furthermore, a reduction ratio of the third rack 95 and the third pinion 96 is substantially equal to a reduction ratio of the fourth rack 105 and the fourth pinion 106.

As a variation, the diameter of the pitch circle of the plurality of third teeth 95b and the diameter of the pitch circle of the plurality of fourth teeth 105b may be different from each other. In this case, the difference between a reduction ratio of the third rack 95 and the third pinion 96 and a reduction ratio of the fourth rack 105 and the fourth pinion 106 may be set to 1% or less of the reduction ratio of the third rack 95 and the third pinion 96. Note that the difference between the reduction ratio of the third rack 95 and the third pinion 96 and the reduction ratio of the fourth rack 105 and the fourth pinion 106 may be 1% or more.

As illustrated in FIG. 1, an ECU 23 includes a first driver 111 and a second driver 112. The ECU 23 further includes, for example, a processing device such as a CPU, a memory such as a ROM and a RAM, and an acceleration sensor. The processing device controls the first driver 111 and the second driver 112 on the basis of, for example, a program read from the memory.

The motor 51a of the first drive device 51 and the motor 61a of the second drive device 61 are connected in parallel to the first driver 111. Therefore, the first driver 111 inputs a common electric signal to the motor 51a of the first drive device 51 and the motor 61a of the second drive device 61. For example, the first driver 111 inputs a common voltage (voltage signal) to the motor 51a of the first drive device 51 and the motor 61a of the second drive device 61.

The motor of the third drive device 91 and the motor of the fourth drive device 101 are connected in parallel to the second driver 112. Therefore, the second driver 112 inputs a common electric signal to the motor of the third drive device 91 and the motor of the fourth drive device 101. For example, the second driver 112 inputs a common voltage (voltage signal) to the motor of the third drive device 91 and the motor of the fourth drive device 101.

The ECU 23 acquires, for example, an acceleration acting on the vehicle 1, from the acceleration sensor. The ECU 23 inputs a common voltage from the first driver 111 to the motor 51a of the first drive device 51 and the motor 61a of the second drive device 61 according to an acceleration in the X direction acting on the vehicle 1.

The first drive device 51 is driven by the input voltage and rotates the first pinion 56. As a result, the first rack 55 rotates about the first central axis Ax1. Furthermore, the second drive device 61 is driven by the input voltage and rotates the second pinion 66. As a result, the second rack 65 rotates about the first central axis Ax1.

The motor 51a of the first drive device 51 and the motor 61a of the second drive device 61 are the same motor. In addition, the reduction device 51b of the first drive device 51 and the reduction device 61b of the second drive device 61 are the same reduction device. Furthermore, the common voltage is input to the first drive device 51 and the second drive device 61. Therefore, a rotation speed of the first pinion 56 driven by the first drive device 51 and a rotation speed of the second pinion 66 driven by the second drive device 61 are substantially the same.

The reduction ratio i₁ of the first rack 55 and the first pinion 56 is substantially equal to the reduction ratio i₂ of the second rack 65 and the second pinion 66. Therefore, a rotation speed of the first rack 55 and a rotation speed of the second rack 65 are substantially the same. Therefore, the first rack 55 and the second rack 65 can rotate synchronously about the first central axis Ax1. In other words, the first rack 55 and the second rack 65 can rotate in parallel about the first central axis Ax1, and can be prevented from being twisted.

For example, when the first drive device 51 and the second drive device 61 are activated, a load acting on the first drive device 51 is sometimes different from a load acting on the second drive device 61. In this case, the rotation speed of the first pinion 56 is different from the rotation speed of the second pinion 66. Therefore, the rotation speed of the first rack 55 is different from the rotation speed of the second rack 65, so that the first rack 55 and the second rack 65 are inclined obliquely with respect to the first central axis Ax1.

When first rack 55 is inclined, part of the first rack 55 comes close to the front support plate 41. In this case, the front guide rollers 43 are in contact with the front surface 55a of the first rack 55 to support the first rack 55.

The front guide rollers 43 restrict the first rack 55 from coming close to the front support plate 41 by being in contact with the first rack 55 rotating about the first central axis Ax1, and at the same time, roll on the front surface 55a of the first rack 55. The front guide rollers 43 keep the first rack 55 and the front support plate 41 apart from each other, and allow the first rack 55 to rotate smoothly about the first central axis Ax1.

Furthermore, when the second rack 65 is inclined, part of the second rack 65 comes close to the rear support plate 44. In this case, the rear guide rollers 46 are in contact with the rear surface 65a of the second rack 65 to support the second rack 65.

The rear guide rollers 46 restrict the second rack 65 from coming close to the rear support plate 44 by being in contact with the second rack 65 rotating about the first central axis Ax1, and at the same time, roll on the rear surface 65a of the second rack 65. The rear guide rollers 46 keep the second rack 65 and the rear support plate 44 apart from each other, and allow the second rack 65 to smoothly rotate about the first central axis Ax1.

As the first rack 55 and the second rack 65 continue to rotate about the first central axis Ax1, the loads acting on the first drive device 51 and the second drive device 61 become substantially equal as time goes by. Therefore, the rotation speed of first rack 55 and the rotation speed of second rack 65 become substantially the same, and the inclinations of the first rack 55 and the second rack 65 are eliminated. However, the first rack 55 and the second rack 65 may remain inclined with respect to the first central axis Ax1.

The ECU 23 rotates the first rack 55 and the second rack 65 to a desired angle about the first central axis Ax1 by driving the first drive device 51 and the second drive device 61 according to the acceleration in the X direction acting on the vehicle 1. As a result, the second rotation mechanism 22 and the seat 12 also rotate about the first central axis Ax1.

The seat surface 12a is inclined by the rotation of the seat 12. As a result, the acceleration in the X direction acting on the passenger on the seat surface 12a is divided into an acceleration in a direction along the seat surface 12a and an acceleration in a direction orthogonal to the seat surface 12a. Therefore, the acceleration in the direction along the seat surface 12a acting on the passenger on the seat surface 12a is reduced, and the acceleration in the X direction felt by the passenger is reduced.

Furthermore, the ECU 23 inputs a common voltage from the second driver 112 to the motor of the third drive device 91 and the motor of the fourth drive device 101 according to an acceleration in the Y direction acting on the vehicle 1.

The third drive device 91 is driven by the input voltage and rotates the third pinion 96. As a result, the third rack 95 rotates about the second central axis Ax2. Furthermore, the fourth drive device 101 is driven by the input voltage and rotates the fourth pinion 106. As a result, the fourth rack 105 rotates about the second central axis Ax2.

The motor of the third drive device 91 and the motor of the fourth drive device 101 are the same motor. In addition, the reduction device of the third drive device 91 and the reduction device of the fourth drive device 101 are the same reduction device. Furthermore, the common voltage is input to the third drive device 91 and the fourth drive device 101. Therefore, a rotation speed of the third pinion 96 driven by the third drive device 91 and a rotation speed of the fourth pinion 106 driven by the fourth drive device 101 are substantially the same.

A reduction ratio of the third rack 95 and the third pinion 96 is substantially equal to a reduction ratio of the fourth rack 105 and the fourth pinion 106. Therefore, a rotation speed of third rack 95 and a rotation speed of the fourth rack 105 are substantially the same. Therefore, the third rack 95 and the fourth rack 105 can rotate synchronously about the second central axis Ax2. In other words, the third rack 95 and the fourth rack 105 can rotate in parallel about the second central axis Ax2, and can be prevented from being twisted.

The ECU 23 rotates the third rack 95 and the fourth rack 105 to a desired angle about the second central axis Ax2 by driving the third drive device 91 and the fourth drive device 101 according to the acceleration in the Y direction acting on the vehicle 1. As a result, the seat 12 also rotates about the second central axis Ax2.

The seat surface 12a is inclined by the rotation of the seat 12. As a result, the acceleration in the Y direction acting on the passenger on the seat surface 12a is divided into an acceleration in a direction along the seat surface 12a and an acceleration in a direction orthogonal to the seat surface 12a. Therefore, the acceleration in the direction along the seat surface 12a acting on the passenger on the seat surface 12a is reduced, and the acceleration in the Y direction felt by the passenger is reduced.

In the vehicle 1 according to the embodiment described above, the acceleration reduction device 10 includes the first rack 55, the first pinion 56, the first drive device 51, the second rack 65, the second pinion 66, the second drive device 61, and the first driver 111. The first rack 55 has the plurality of first teeth 55c arranged around the virtual first central axis Ax1. The first pinion 56 meshes with the plurality of first teeth 55c. The first drive device 51 is configured to rotate the first pinion 56. The second rack 65 has the plurality of second teeth 65c arranged around the first central axis Ax1. The second pinion 66 meshes with the plurality of second teeth 65c. The second drive device 61 is configured to rotate the second pinion 66. The first driver 111 inputs a common electric signal to the first drive device 51 and the second drive device 61. The first rack 55 and the second rack 65 are apart from each other in the first axial direction along the first central axis Ax1. The diameter of the pitch circle Pc1 of the plurality of first teeth 55c is different from the diameter of the pitch circle Pc2 of the plurality of second teeth 65c. The reduction ratio i₁ of the first rack 55 and the first pinion 56 and the reduction ratio i₂ of the second rack 65 and the second pinion 66 are set such that the first rack 55 and the second rack 65 rotate synchronously about the first central axis Ax1 with respect to the first pinion 56 and the second pinion 66 when the first driver 111 inputs the electric signal to the first drive device 51 and the second drive device 61.

That is, an acceleration reduction device includes: a first rack having a plurality of first teeth arranged around a virtual first central axis; a first pinion that meshes with the plurality of first teeth; a first drive device configured to rotate the first pinion; a second rack having a plurality of second teeth arranged around the virtual first central axis; a second pinion that meshes with the plurality of second teeth; a second drive device configured to rotate the second pinion; and a first driver that inputs a common electric signal to the first drive device and the second drive device. The first rack and the second rack are apart from each other in a first axial direction along the virtual first central axis, a diameter of a pitch circle of the plurality of first teeth is different from a diameter of a pitch circle of the plurality of second teeth, and a reduction ratio of the first rack and the first pinion and a reduction ratio of the second rack and the second pinion are set such that the first rack and the second rack rotate synchronously about the virtual first central axis with respect to the first pinion and the second pinion when the first driver inputs the common electric signal to the first drive device and the second drive device.

According to the above configuration, when the single first driver 111 inputs the common electric signal to the first drive device 51 and the second drive device 61, the first rack 55 and the second rack 65 can rotate at substantially the same rotation speed about the first central axis Ax1. As a result, when a member such as the seat 12 or a table is attached to the first rack 55 and the second rack 65, the member can rotate about the first central axis Ax1 without being twisted. In addition, the acceleration reduction device 10 can drive the two rack-and-pinion mechanisms in which diameters of the pitch circles of the racks are different, at substantially the same rotation speed as described above; therefore, a degree of freedom (flexibility) of layout of various parts can be improved. In addition, as compared with a case where the first rack 55 and the second rack 65 are driven by separate drivers, the acceleration reduction device 10 can drive the first drive device 51 and the second drive device 61 by the single first driver 111, and can therefore reduce the cost and the size.

According to the acceleration reduction device of the present disclosure, even when a distance between the first central axis and the first rack is different from a distance between the first central axis and the second rack, the first rack and the second rack can be rotated at substantially the same rotation speed when a common electric signal is input from the single first driver to the first drive device and the second drive device.

(2) The first rack 55 and the second rack 65 are apart from each other in the horizontal direction. The first pinion 56 is located above or below the first rack 55. The second pinion 66 is located above or below the second rack 65.

That is, in the acceleration reduction device, the first rack and the second rack are apart from each other in a horizontal direction, the first pinion is located above or below the first rack, and the second pinion is located above or below the second rack.

According to the above configuration, the first rack 55 and the first pinion 56 are not aligned horizontally, and the second rack 65 and the second pinion 66 are not aligned horizontally either. Therefore, the acceleration reduction device 10 can be downsized in the horizontal direction as compared with a case where the rack and the pinion are arranged in the horizontal direction.

(3) The first rack 55 is located below the second rack 65. The first pinion 56 is located below the first rack 55.

That is, in the acceleration reduction device, the first rack is located below the second rack, and the first pinion is located below the first rack.

According to the above configuration, since the first rack 55 is located below the second rack 65, the passenger of the vehicle 1 is more likely to receive, for example, liquid spilled or splashed by a passenger of the vehicle 1 than the second rack 65. However, since the first pinion 56 is located below the first rack 55, the plurality of first teeth 55c protrudes substantially downward. Therefore, when the first rack 55 receives liquid, the liquid can be discharged from the gap between the plurality of first teeth 55c by the gravity.

(4) The acceleration reduction device 10 includes the first rotation mechanism 21, the second rotation mechanism 22, and the second driver 112. The first rotation mechanism 21 includes the first rack 55, the first pinion 56, the first drive device 51, the second rack 65, the second pinion 66, and the second drive device 61. The second rotation mechanism 22 includes the third rack 95, the third pinion 96, the third drive device 91, the fourth rack 105, the fourth pinion 106, and the fourth drive device 101. The third rack 95 includes the plurality of third teeth 95b arranged around the virtual second central axis Ax2 and meshing with the third pinion 96. The third drive device 91 is configured to rotate the third pinion 96. The fourth rack 105 includes the plurality of fourth teeth 105b arranged around the second central axis Ax2 and meshing with the fourth pinion 106. The fourth drive device 101 is configured to rotate the fourth pinion 106. The second driver 112 inputs a common electric signal to the third drive device 91 and the fourth drive device 101. The second central axis Ax2 extends in the second axial direction intersecting the first axial direction. The third rack 95 and the fourth rack 105 are apart from each other in the second axial direction. The first rotation mechanism 21 is attached to the second rotation mechanism.

That is, the acceleration reduction device includes: a first rotation mechanism including the first drive device, the first pinion, the first drive device, the second rack, the second pinion, and the second drive device; a second rotation mechanism including: a third rack; a third pinion; a third drive device configured to rotate the third pinion; a fourth rack; a fourth pinion; and a fourth drive device configured to rotate the fourth pinion; and a second driver that inputs a common electric signal to the third drive device and the fourth drive device. The third rack includes a plurality of third teeth arranged around a virtual second central axis and meshing with the third pinion, the fourth rack includes a plurality of fourth teeth arranged around the virtual second central axis and meshing with the fourth pinion, the virtual second central axis extends in a second axial direction intersecting the first axial direction, the third rack and the fourth rack are apart from each other in the second axial direction, and the first rotation mechanism is attached to the second rotation mechanism.

According to the above configuration, since the two rotation mechanisms (the first rotation mechanism 21 and the second rotation mechanism 22) are combined, the acceleration reduction device 10 can rotate a member such as the seat 12 about two axes, and as a result, can more reliably reduce the acceleration acting on a person (passenger) or an object on the member. In addition, at least one (the first rotation mechanism 21) of the two rotation mechanisms can drive the two rack-and-pinion mechanisms having different diameters of the pitch circles of the racks at substantially the same rotation speed as described above, so that the degree of freedom (flexibility) of layout of various parts can be improved.

(5) The acceleration reduction device 10 further includes the front support plate 41, the front guide rollers 43, the rear support plate 44, and the rear guide rollers 46. The front support plate 41 supports the first drive device 51. The front guide rollers 43 are attached to the front support plate 41 to be rotatable about the central axis Axr extending in a radial direction orthogonal to the first central axis Ax1. The front guide rollers 43 are configured to restrict, by being in contact with the first rack 55 that rotates about the first central axis Ax1, the first rack 55 from coming close to the front support plate 41, and are configured to roll on the front surface 55a of the first rack 55. The rear support plate 44 supports the second drive device 61. The rear guide rollers 46 are attached to the rear support plate 44 to be rotatable about the central axis Axr extending in a radial direction orthogonal to the first central axis Ax1. The rear guide rollers 46 are configured to restrict, by being in contact with the second rack 65 that rotates about the first central axis Ax1, the second rack 65 from coming close to the rear support plate 44, and are configured to roll on the rear surface 65a of the second rack 65.

That is, the acceleration reduction device further includes: a first support portion configured to support the first drive device; a first roller attached to the first support portion to be rotatable about a third central axis extending in a radial direction orthogonal to the virtual first central axis, the first roller configured to restrict, by being in contact with the first rack that rotates about the virtual first central axis, the first rack from coming close to the first support portion, and the first roller configured to roll on a surface of the first rack; and a second support portion that supports the second drive device; and a second roller attached to the second support portion to be rotatable about a fourth central axis extending in a radial direction orthogonal to the virtual first central axis, the second roller configured to restrict, by being in contact with the second rack that rotates about the virtual first central axis, the second rack from coming close to the second support portion, and the second roller configured to roll on a surface of the second rack.

According to the above configuration, for example, when the load acting on the first drive device 51 is different from the load acting on the second drive device 61, the rotation speed of the first rack 55 may be different from the rotation speed of the second rack 65. In this case, the first rack 55 and the second rack 65 are twisted with respect to the first central axis Ax1, so that the first rack 55 comes close to the front support plate 41 and the second rack 65 comes close to the rear support plate 44. By coming into contact with the first rack 55 that is close to the front support plate 41, the front guide rollers 43 can prevent the first rack 55 from coming into contact with the front support plate 41, and at the same time, can guide the first rack 55 to smoothly rotate about the first central axis Ax1. That is, the front guide rollers 43 can prevent the first rack 55 from coming into contact with the front support plate 41 and thereby becoming unable to rotate. In addition, by coming into contact with the second rack 65 that is close to the rear support plate 44, the rear guide rollers 46 can prevent the second rack 65 from coming into contact with the rear support plate 44, and at the same time, can guide the second rack 65 to smoothly rotate about the first central axis Ax1. That is, the rear guide rollers 46 can prevent the second rack 65 from coming into contact with the rear support plate 44 and thereby becoming unable to rotate. Even when the first rack 55 and the second rack 65 are twisted with respect to the first central axis Ax1, the imbalance between the loads acting on the first rack 55 and the second rack 65 can be removed as time goes by when the first rack 55 and the second rack 65 continue to rotate. Therefore, the acceleration reduction device 10 can eventually make the rotation speed of first rack 55 and the rotation speed of second rack 65 substantially the same. The acceleration reduction device 10 may include any one of a group of the front support plate 41 and the front guide rollers 43 and a group of the rear support plate 44 and the rear guide rollers 46. Furthermore, for example, the right rail 85 may be provided with a guide roller that rolls on a surface of the third rack 95, and the left rail 86 may be further provided with a guide roller that rolls on a surface of the fourth rack 105.

The first central axis Ax1, the central axis Axm1 of the first pinion 56, and the central axis Axm2 of the second pinion 66 are linearly arranged in the radial direction orthogonal to the first central axis Ax1.

The first rack 55 is generally set such that the first pinion 56 is located at the middle of the first rack 55 in a normal state. In addition, the second rack 65 is generally set such that the second pinion 66 is located at the middle of the second rack 65 in a normal state. Therefore, according to the above configuration, the acceleration reduction device 10 can prevent the first rack 55 and the second rack 65 from being disposed to be displaced about the first central axis Ax1; therefore, a width of the acceleration reduction device 10 in the X direction can be reduced, for example.

In the above, the embodiment and the variation of the present disclosure have been described; however, the above-mentioned embodiment and the variations are merely examples and are not intended to limit the scope of the present disclosure. The above-mentioned embodiment and the variations can be performed in various aspects; and various omissions, replacement, changes, and combinations can be made without departing from the gist of the present disclosure. In addition, the configuration and shape of each embodiment and each variation can be partially exchanged for practice of the present disclosure.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An acceleration reduction device comprising:
a first rack having a plurality of first teeth arranged around a virtual first central axis;
a first pinion that meshes with the plurality of first teeth;
a first drive device configured to rotate the first pinion;
a second rack having a plurality of second teeth arranged around the virtual first central axis;
a second pinion that meshes with the plurality of second teeth;
a second drive device configured to rotate the second pinion; and
a first driver that inputs a common electric signal to the first drive device and the second drive device,
wherein the first rack and the second rack are apart from each other in a first axial direction along the virtual first central axis,
a diameter of a pitch circle of the plurality of first teeth is different from a diameter of a pitch circle of the plurality of second teeth, and
a reduction ratio of the first rack and the first pinion and a reduction ratio of the second rack and the second pinion are set such that the first rack and the second rack rotate synchronously about the virtual first central axis with respect to the first pinion and the second pinion when the first driver inputs the common electric signal to the first drive device and the second drive device.

2. The acceleration reduction device according to claim 1, wherein the first rack and the second rack are apart from each other in a horizontal direction, and
the first pinion is located above or below the first rack, and
the second pinion is located above or below the second rack.

3. The acceleration reduction device according to claim 2, wherein the first rack is located below the second rack, and
the first pinion is located below the first rack.

4. The acceleration reduction device according to claim 1, further comprising:
a first rotation mechanism including the first drive device, the first pinion, the first drive device, the second rack, the second pinion, and the second drive device;
a second rotation mechanism including:
a third rack;
a third pinion;
a third drive device configured to rotate the third pinion;
a fourth rack;
a fourth pinion; and
a fourth drive device configured to rotate the fourth pinion; and
a second driver that inputs a common electric signal to the third drive device and the fourth drive device,
wherein the third rack includes a plurality of third teeth arranged around a virtual second central axis and meshing with the third pinion,
the fourth rack includes a plurality of fourth teeth arranged around the virtual second central axis and meshing with the fourth pinion,
the virtual second central axis extends in a second axial direction intersecting the first axial direction,
the third rack and the fourth rack are apart from each other in the second axial direction, and
the first rotation mechanism is attached to the second rotation mechanism.

5. The acceleration reduction device according to claim 1, further comprising:
a first support portion configured to support the first drive device;
a first roller attached to the first support portion to be rotatable about a third central axis extending in a radial direction orthogonal to the virtual first central axis, the first roller configured to restrict, by being in contact with the first rack that rotates about the virtual first central axis, the first rack from coming close to the first support portion, and the first roller configured to roll on a surface of the first rack; and
a second support portion that supports the second drive device; and
a second roller attached to the second support portion to be rotatable about a fourth central axis extending in a radial direction orthogonal to the virtual first central axis, the second roller configured to restrict, by being in contact with the second rack that rotates about the virtual first central axis, the second rack from coming close to the second support portion, and the second roller configured to roll on a surface of the second rack.
